(19) United States
(12) Patent Application Publication
(10) Pub. No.: US 2024/0247482 A1
(43) Pub. Date: Jul. 25, 2024

(54) WALL ELEMENT FOR THERMAL INSULATION OF AN INTERIOR WALL SURFACE

(71) Applicant: Maria Leitl, Furniere und Laubschnittholz OG, Wördern (AT)

(72) Inventor: Mieczyslaw Kazimierz BYRTEK, Zarzecze (PL)

(21) Appl. No.: 18/417,401

(22) Filed: Jan. 19, 2024

(30) Foreign Application Priority Data
Jan. 19, 2023 (EP) 23152507.2

(51) Int. Cl. E04B 1/80; B32B 3/08; B32B 5/02; B32B 21/02; B32B 21/10; B32B 25/10; B32B 25/14; E04B 1/76; E04B 1/90

(52) U.S. Cl. CPC E04B 1/80; B32B 3/085; B32B 5/022; B32B 21/02; B32B 21/10; B32B 25/10; B32B 25/14; E04B 1/7675; E04B 1/90; B32B 2307/102; B32B 2307/304; B32B 2307/51; B32B 2307/7246; B32B 2607/00

(57) ABSTRACT

A wall element for thermal insulation of an interior wall surface, having an elastic insulating panel, includes at least two slat-shaped lamellas. The at least two slat-shaped lamellas are spaced apart from one another and are arranged parallel to one another on a front side of the elastic insulating panel, so that the elastic insulating panel is mechanically stabilised by the slat-shaped lamellas. The slat-shaped lamellas include a wood-based material.

The invention relates to a wall element for the thermal insulation of an interior wall surface, comprising an elastic insulating panel.

Furthermore, the invention relates to a method for the thermal insulation of an interior wall surface, wherein the method comprises at least one repetition of the following steps:
providing a wall element with an elastic insulating panel;
attaching the wall element to an interior wall surface, wherein a first end face of the elastic insulating panel flushes with a second end face of a further elastic insulating panel of an already fastened wall element.

Increasing energy efficiency is gaining importance in all areas, especially due to steadily rising energy costs and a greater awareness of the imminent dangers posed by climate change. In particular, heating comes into focus in this context, since on the one hand large amounts of energy have to be spent, but on the other hand savings measures are sometimes relatively easy to implement. According to the Austrian Energy Agency, both the heating costs and the associated CO: emissions of a renovated building can be 50 percent lower than those of an unrenovated building. In addition to renovating doors and windows, for example, heat losses through external walls can be reduced by thermally insulating the external walls accordingly. For this purpose, insulation is typically added to the outer wall surface. The insulation must be weatherproof or covered accordingly. If an existing building is subsequently provided with such insulation, this can result in a relatively high outlay and associated high costs.

Alternatively or in addition to adding insulation to the outer wall surface, thermal insulation may be attached to an interior wall surface. This is often easier and cheaper than providing the outer wall surface with insulation. On the one hand, because there are less stringent requirements for thermal insulation in terms of weather resistance in the interior, and on the other hand, because installing the thermal insulation on individual floors is easier than providing insulation to an entire exterior side of the building, and can therefore also be carried out by non-professionals.

For example, a surface covering for walls is known from U.S. Pat. No. 3,385,743 A. The surface cover has a veneer layer supported by a paper layer. The paper layer has a layer of polyethylene, which acts as a barrier for moisture and heat. Furthermore, an adhesive layer is provided, which is protected by a removable separating sheet. To adhere the surface cover to a wall, the separating sheet is removed.

DE 20 2006 001 433 U1 shows a thin-film covering for floors, walls and ceilings with a flexible base layer and a noble surface layer with real wood veneer. A backing layer and thermal insulation are provided. Adequate stability of the thin-film coating is ensured by a base layer structure.

CN 2016 49 320 U discloses a decorative composite panel for thermal insulation. The composite panel has several layers which are bonded together. An adhesive layer, an insulation layer, a waterproof layer, a fibreglass layer and a decorative element are provided.

A disadvantage of the known coverings is that joints are created between the individual elements, which are not completely closed. For example, air moisture can penetrate a gap between two flush elements of paper or glass fibres. It is therefore necessary to bond the joints in a separate step to ensure continuous insulation. Furthermore, the known coverings have little or no flexibility, which is why curved wall sections are difficult or impossible to provide with the known coverings.

Furthermore, self-adhesive flexible insulating mats made of rubber are the general state of the art. Due to the high flexibility of insulation mats, they can be used in a variety of ways and can be attached, for example, to water pipes, heating systems or even walls. Due to the low thermal conductivity and the high water vapour diffusion resistance of rubber, energy losses can be avoided and the penetration of water vapour and the interaction of water vapour with the object to be insulated can be prevented. Due to the elasticity of rubber, it is possible to lay two insulation mats next to each other in such a way that no gap arises between the two insulation mats. This makes it possible to eliminate the need for separate bonding or pasting over of joints or gaps.

The high flexibility of insulation mats is advantageous for attachment to highly curved objects such as pipelines with a relatively small diameter, for example only a few centimetres or decimetres. However, the flexibility has a disadvantageous effect on the attachment on walls, since the handling of larger sections of a flexible insulation mat is not easily possible. For example, in order to attach an insulation mat to a wall over a large area, essentially every point of the insulation mat must be pressed separately against the wall due to its flexibility. Accordingly, installation on a wall is tedious and sometimes only possible with the help of a ladder, so that even higher-up sections of the insulation mat can be suitably attached. In addition, the flexibility and pliability make it difficult to handle the still loose insulation mat and align it on the wall.

It is therefore an object of the invention to alleviate disadvantages from the state of the art and to provide a wall element for thermal insulation of interior wall surfaces, which can be attached in a simple manner to flat and curved interior wall surfaces.

The object according to the invention is achieved by a wall element according to claim 1 and a method according to claim 13. Preferred embodiments are given in the dependent claims.

The wall element according to the invention has at least two slat-shaped lamellas, wherein the at least two slat-shaped lamellas are spaced apart from one another and arranged parallel to one another on a front side of the elastic insulating panel, so that the elastic insulating panel is mechanically stabilised by the slat-shaped lamellas, wherein the slat-shaped lamellas comprise a wood-based material.

In the method according to the invention for thermal insulation of an interior wall surface, the wall element has at least two slat-shaped lamellas, wherein the at least two slat-shaped lamellas are arranged at a distance from one another and parallel to one another on a front side of the elastic insulating panel, in order to mechanically stabilise the elastic insulating panel during attachment.

The wall element can be used for thermal insulation of an interior wall surface. The interior wall surface may be, for example, a wall surface in the interior of a building. The interior wall surface may be part of an outer wall, namely the side of the outer wall directed towards the interior of the building. The interior wall surface (or wall surface for short) can also be part of a wall that separates two rooms or two residential units within a building. In order to provide an interior wall surface with thermal insulation, at least one wall element can be attached to the interior wall surface. Typically, it is necessary to attach several wall elements next to each other in order to insulate an entire interior wall surface. Attaching multiple smaller wall elements is easier than attaching a single large wall element.

The elastic insulating panel comprises an insulating material, such as rubber or polyurethane foam, for example. The elastic insulating panel can be designed as a multilayer structure. For example, the elastic insulating panel may have layers of rubber and aluminium foil. In the following, the terms “elastic insulating panel” and “insulating panel” will be used synonymously. The term “insulating panel” therefore refers to the “elastic insulating panel” and vice versa. In order to mechanically stabilise the insulating panel during the installation of the wall element, the wall element has at least two slat-shaped lamellas. The at least two slat-shaped lamellas are spaced apart from one another and arranged parallel to one another on a front side of the elastic insulating panel. For example, the slat-shaped lamellas are adhered to the front side of the elastic insulating layer. The slat-shaped lamellas can be, for example, rods with a substantially rectangular, in particular square, cross-section. The slat-shaped lamellas comprise a wood-based material. In the following, the terms “slat-shaped lamella” and “lamella” are used synonymously. The term “lamella” therefore refers to the “slat-shaped lamella” and vice versa.

The elastic insulating panel is also flexible, making it easy to attach even on curved walls. For example, a wall element may be provided that extends over the entire height of a vertical and planar interior wall surface. For example, the interior wall element may have a length of 1.5 metres to 3 metres, wherein the length of the wall element may correspond, for example, to the height of a room and thus to the height of an interior wall surface. The lamellas can be aligned parallel to the longitudinal side. If the wall element is attached to the interior wall surface, the lamellas can be aligned vertically from top to bottom parallel to the interior wall surface. Despite the length of the wall element and the height of the interior wall surface, it is not necessary, for example, to use a ladder when attaching the wall element due to the lamellas. Due to the mechanical stabilisation provided by the lamellas along the longitudinal direction of the lamellas and consequently along the height of the interior wall surface, the wall element can be easily attached to the interior wall surface. For example, a normal force may be applied to individual lamellas, which is transmitted to the insulating panel. The lamellas thus bring about a stability of the wall element and simplify the installation already on flat interior wall surfaces.

Normal to the main axis of the parallel aligned lamellas, the insulating panel, and consequently the entire wall element, can be bent. As a result, the wall element can be attached particularly easily on curved interior wall surfaces, for example on lateral surfaces of a cylindrical ductwork. For this purpose, the lamellas may be oriented parallel to the direction along which the interior wall surface has no curvature, in the case of a cylindrical ductwork, parallel to the main axis of the cylindrical shaft. For example, the wall element can be rotated accordingly to ensure alignment of the lamellas. Thus, the lamellas also simplify the installation of the wall element on curved interior wall surfaces.

For thermal insulation of the interior wall surface, a wall element with an elastic insulating panel is provided. The wall element has at least two slat-shaped lamellas, wherein the at least two slat-shaped lamellas are arranged at a distance from one another and parallel to one another on a front side of the elastic insulating panel, in order to mechanically stabilise the elastic insulating panel during attachment. The wall element is attached to the interior wall surface. In this case, a first end face of the elastic insulating panel flushes with a second end face of a further elastic insulating panel of an already fastened wall element. The first end face and the second end face stand transversely, in particular normally, on the front side of the elastic insulating panel. The first and second end faces are side faces of the insulating panel, respectively. The shape of the insulating panel may, for example, substantially correspond to a cuboid. In this case, the end faces are substantially normal to the front side, wherein the front side is parallel to the main extension plane of the insulating panel. The insulating panel has a back side, wherein the back side is a side of the insulating panel facing away from the front side. The back side may be substantially parallel to the front side. The shape of the insulating panel may, for example, correspond to a parallelepiped, wherein the front side and the back side may be rectangular. The side faces run along the periphery of the insulating panel. For example, the first and second end faces may be parallel to the major axes of the lamellas. The first and second end faces may each include an angle with the main plane of extension of the insulating panel such that the sum of these two angles is 180°, wherein both angles are each greater than 0°. If two wall elements lie against one another, the first end face of one wall element and the second end face of an adjacent wall element thus lie flat against one another. By attaching a plurality of adjoining wall elements to an interior wall surface, continuous thermal insulation of the interior wall surface can be achieved.

The lamellas may have a body made of wood-based material, for example. The body may have a back side, wherein the back side of the lamella may be adhered to the front side of the flexible insulating panel. The lamella may further have a front side opposite the back side and two longitudinal side faces. A decorative layer can be arranged on the body, wherein the decorative layer can extend at least over the front side of the lamella. Furthermore, the decorative layer may extend over at least one longitudinal side face of the lamella. For example, the decorative layer may have a real wood veneer. Alternatively, the decorative layer may have a printed plastic film.

For example, the insulating panel may extend laterally in a longitudinal direction and laterally in a transverse direction, wherein the insulating panel extends further in the longitudinal direction than in the transverse direction, wherein the slat-shaped lamellas are aligned parallel to the longitudinal direction. The ratio between length (in the longitudinal direction) and width (in the transverse direction) can be greater than 1.5, in particular greater than or equal to 2. The insulating panel may, for example, have a length of 0.4 m (metres) to 3 m in the longitudinal direction. For example, the insulating panel may have a width of 0.2 m to 1 m in the transverse direction. The thickness of the insulating panel may, for example, be within a range of 0.3 cm to 2.5 cm. The thickness of the insulating panel relates to an extension of the insulating panel normal to the main extension plane of the insulating panel. The lamellas may be oriented parallel to the longitudinal direction in order to stabilise the insulating panel in the direction of greatest expansion, that is, in the longitudinal direction. The lamellas may have a width in the transverse direction of, for example, 2 cm to 4 cm. The length of the lamellas in the longitudinal direction may essentially correspond to the length of the insulating panel in the longitudinal direction. Accordingly, the lamellas may be significantly longer than wide in order to ensure mechanical stabilisation, preferably in the longitudinal direction, and at the same time to maintain flexibility transversely thereto. Due to the relatively narrow width and the normal distance of the lamellas from one another (i.e. between the lamellas), the insulating panel and, consequently, the wall element, can be bent in a direction normal to the main axis of the lamellas, in particular in the transverse direction.

For example, the elastic insulating panel can be water vapour diffusion-inhibiting, in particular water vapour diffusion-tight. For thermal insulation, it is advantageous if the thermal conductivity of the insulating material is as low as possible in order to avoid a thermal bridge between the interior and the wall as much as possible. It is also advantageous if as little air moisture as possible reaches the interior wall surface. Air moisture could—if it exceeds a level that can diffuse through the wall, for example—condense on the (cold) interior wall surface on the one hand and thus damage the wall and/or the wall element. In particular, condensed air moisture could lead to the formation of mould. On the other hand, air moisture can efficiently contribute to temperature compensation due to the high heat capacity of water molecules and the diffusion properties of the water molecules. In order to prevent precisely this temperature equalisation between the interior and the wall via the interior wall surface, the water vapour diffusion should therefore at least be inhibited and ideally prevented. For this purpose, the insulating panel can be water vapour diffusion-inhibiting, for example with a water vapour diffusion-equivalent air layer thickness (s_{d}-value) of at least 100 m (metres). Particularly, the elastic insulating panel may be water vapour diffusion-tight, for example, with a water vapour diffusion equivalent air layer thickness (Sa-value) of at least 1,500 m. For example, chloroprene rubber (also known as neoprene) has a water vapour diffusion resistance of 10,000. If the insulating panel has chloroprene rubber with a thickness of 2 cm, the water vapour diffusion equivalent air layer thickness is 200 m (Sa-value=10,000*0.02 m=200 m). Natural rubber also has a water vapour diffusion resistance of 10,000, while, for example, butyl rubber has a water vapour diffusion resistance of 200,000.

The elastic insulating panel may have such an elasticity that unevennesses on an interior wall surface of up to 7 mm can be compensated for, and that a continuous water vapour diffusion-inhibiting insulating layer can be formed on the interior wall surface by means of the elastic insulating panel and a further elastic insulating panel of an adjacent wall element.

When attaching the wall element, a normal force from the first end face of the elastic insulating panel can act laterally on the second end face of the further elastic insulating panel of the already fastened wall element, so that the elastic insulating panel forms a continuous insulating layer on the interior wall surface with the further elastic insulating panel of the already fastened adjacent wall element.

Due to the elasticity, the insulating panel is compressed by the normal force on the first end face, i.e. in the area of the end face. Likewise, the further insulating panel of the already fastened wall element is compressed on the second end face due to the normal force. As a result of this compression and an opposite expansion in the event of a possible decrease in the normal force, any joint and any gap between two adjacent wall elements are ultimately closed and thus avoided. Two adjacent insulating panels therefore form a continuous insulating layer on the interior wall surface. If the insulating panel is diffusion-inhibiting, the continuous insulating layer is also water vapour diffusion-inhibiting. If the insulating panel is water vapour diffusion-tight, the continuous insulating layer is also water vapour diffusion-tight. This means that the local water vapour diffusion-inhibiting or water vapour diffusion-tight effect of the continuous insulating layer can be (at least) the same at the contact points between the insulating panels as in the centre of an individual insulating panel. This eliminates the need for separate bonding or pasting over of joints or gaps.

Furthermore, due to the elasticity of the elastic insulating panel, a consistent bond with the interior wall surface can be achieved, even if the interior wall surface has unevennesses with a typical size of up to 7 mm (millimetres). The elastic insulating panel can compensate for such unevenness (e.g., by pressing local elevations into the insulating panel) and thereby prevent air pockets between the interior wall surface and the wall element.

The elastic insulating panel may have an average thermal conductivity of a maximum of 0.04 watts per metre per Kelvin (W/m K). As a result, heat transfer from the wall to the interior space, in particular to the room air and objects such as furniture in the room, is suppressed.

The elastic insulating panel may comprise, for example, rubber, in particular a rubber elastomer. Both rubber and rubber elastomers may have a low thermal conductivity, form water vapour diffusion-inhibiting layers, in particular water vapour diffusion-tight layers, and at the same time offer sufficient elasticity and flexibility. Particularly, the elastic insulating panel may comprise a non-porous rubber elastomer.

The wood-based material may be, for example, a solid wood or a wood fibre material, in particular a medium-density wood fibre material, high-density wood fibre material (“HDF”), a wood chip material, or plywood. For example, the body of the lamella may consist of a solid wood or a wood fibre material, in particular a medium-density wood fibre material, high-density wood fibre material (“HDF”), a wood chip material, or plywood. The mechanical properties of wood-based materials are particularly suitable for producing slat-shaped lamellas from them, which ensure the mechanical stability of the elastic insulating layer. Due to the arrangement of the lamellas on the front side of the insulating layer, which in intended use forms the visible side of the wall element, the lamellas are visible and accessible in an interior space. Wood-based materials contribute to a pleasant indoor climate and can be used without hesitation, for example with regard to toxic properties.

For example, at least three, in particular at least ten, slat-shaped lamellas may be provided, wherein the slat-shaped lamellas are arranged equidistantly on the front side of the elastic insulating panel. The use of several slat-shaped lamellas can improve the mechanical stability of the wall element. On the one hand, the homogeneity of the mechanical properties of the elastic insulating panel can be improved by the equidistant arrangement of the lamellas on the front side of the elastic insulating panel. On the other hand, equidistant visible lamellas in rooms are perceived as aesthetic, so that an improved decorative effect can also be achieved at the same time as the thermal insulation.

For example, the normal distance between two adjacent lamellas may be at least 0.1 times and at most 1.5 times the width of a lamella. It is advantageous if the normal distance between two adjacent lamellas of adjacent wall elements corresponds to the normal distance between two adjacent lamellas on the same wall element. The wall element may have a first outer lamella and a second outer lamella. The first outer lamella is the lamella that has the smallest normal distance to the first end face. The second outer lamella is the lamella that has the smallest normal distance to the second end face. If two wall elements lie against one another, the first end face of a wall element lies against the second end face of a further already fastened wall element. Consequently, the first outer lamella of the wall element is adjacent to the second outer lamella of the further already fastened wall element. In order to determine the normal distance between these two lamellas corresponding to the normal distance between two lamellas on a wall element, the normal distance of the first outer lamella to the first end face may correspond to the normal distance of the second outer lamella to the second end face of the (same) wall element to the normal distance between two adjacent wall elements.

For example, a first longitudinal section of an outer slat-shaped lamella may extend across the front side of the elastic insulating panel, and a second longitudinal section of the outer slat-shaped lamella may not extend across the front side of the elastic insulating panel. The outer lamella has a first plane of symmetry normal to the main plane of extension of the insulating panel and parallel to the main axis of the outer lamella. The first longitudinal section and the second longitudinal section may lie on different sides with respect to the first plane of symmetry, for example. Alternatively, the first and second longitudinal sections may have different widths, i.e., transverse extensions. The outer lamella, for example the first outer lamella, can thus partially protrude beyond the front side of the insulating panel. As a result, a joint between two adjacent wall elements can be covered by the second longitudinal section of the outer lamella by the second longitudinal section of the outer lamella protruding over the insulating panel of the adjacent wall element. Thus, the joint between two adjacent wall elements is covered by the outer lamella.

For example, the lamellas may have a cross-sectional area of at least 36 mm², in particular exactly 165 mm², wherein the cross-sectional area is normal to a main axis of the lamella. The cross-sectional area of the lamella has a significant influence on the mechanical properties of the lamellas and consequently on the mechanical properties of the wall element. A cross-sectional area of at least 36 mm², in particular exactly 165 cm², leads to mechanical properties of the wall element that promote simple installation. In particular, this selection brings about sufficient stability without greatly impairing the flexibility of the wall element. The lamellas may have a cross section of 1.8 mm by 20 mm, for example. The lamellas may have a width in the transverse direction of 20 mm to 40 mm, for example. The lamellas may have a thickness of 1.8 mm to 12 mm, for example.

An adhesive surface, in particular formed by double-sided adhesive tape, may be provided on a back side of the insulating panel, wherein the adhesive surface is covered with a protective film, wherein the back side is a side of the insulating panel facing away from the front side, wherein the adhesive surface is suitable for permanently fixing the wall element to an interior wall surface. The adhesive surface with the protective film can significantly simplify the installation of the wall element overall, since no separate adhesive has to be applied to the interior wall surface and/or the wall element during the attachment of the wall element. The mechanical stabilisation of the insulating panel due to the lamellas simplifies the installation of the wall element also in connection with the adhesive surface. On the one hand, the mechanical stabilisation simplifies the removal of the protective film from the adhesive surface on the elastic insulating panel. On the other hand, the lamellas prevent the insulating panel from rolling up independently, which also prevents parts of the insulating panel from sticking to other parts of the same insulating panel.

In the method for thermal insulation of the interior wall surface, an adhesive surface may be provided on a back side of the elastic insulating panel, wherein the back side is a side of the elastic insulating panel facing away from the front side, wherein the adhesive surface is covered with a protective film, wherein attaching the wall element includes adhering the wall element by means of the adhesive surface, wherein the method further comprises the following step before attaching the wall element:
peeling off the protective film from the adhesive surface.

In comparison to the manual application of an adhesive, the removal of the protective film is much easier. Overall, this enables a simple method for thermal insulation of an interior wall surface.

A sound absorber, in particular a felt layer, may be attached to the front side of the elastic insulating panel, wherein the sound absorber is arranged between the elastic insulating panel and the slat-shaped lamellas. The sound absorber may be a thin flexible layer, for example made of felt, wool, hemp wool or MDF, which at least attenuates, in particular absorbs, incoming sound. The sound absorber may be extended, for example, over the entire front side of the insulating panel. In addition, a portion of the insulating layer may not extend across the front side of the elastic insulating panel. The portion of the insulating layer that is not arranged over the front side of the elastic insulating layer may be used, for example, to cover a joint between two adjacent wall elements.

The present invention will be explained in more detail below with reference to exemplary embodiments illustrated in the drawings, to which, however, it is not intended to be limited, and with reference to the drawings.

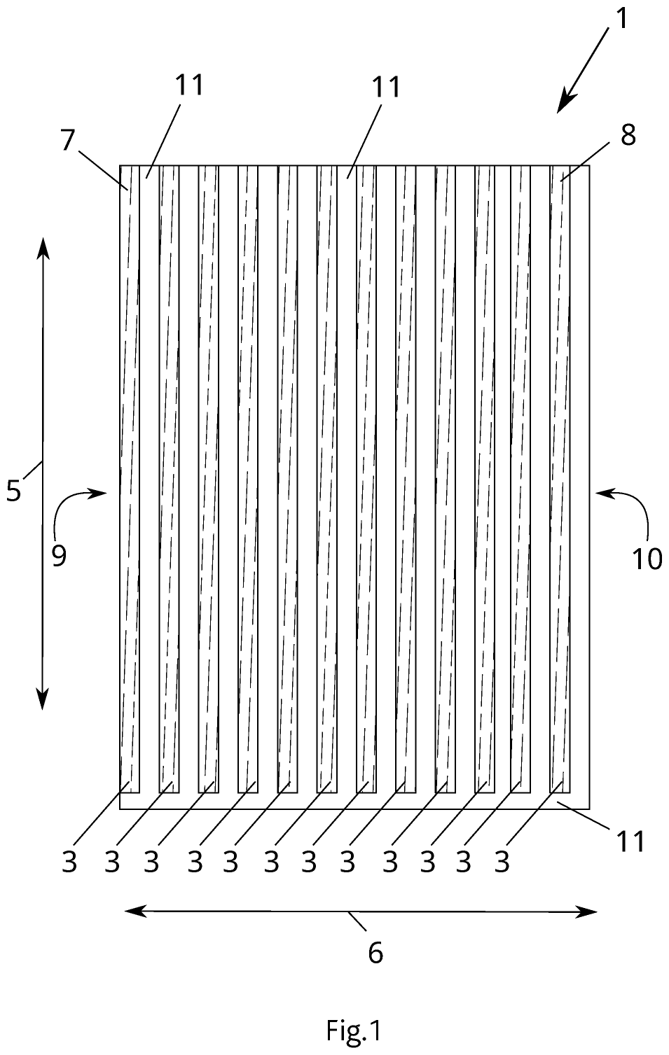

FIG. 1 shows a front view of a wall element.

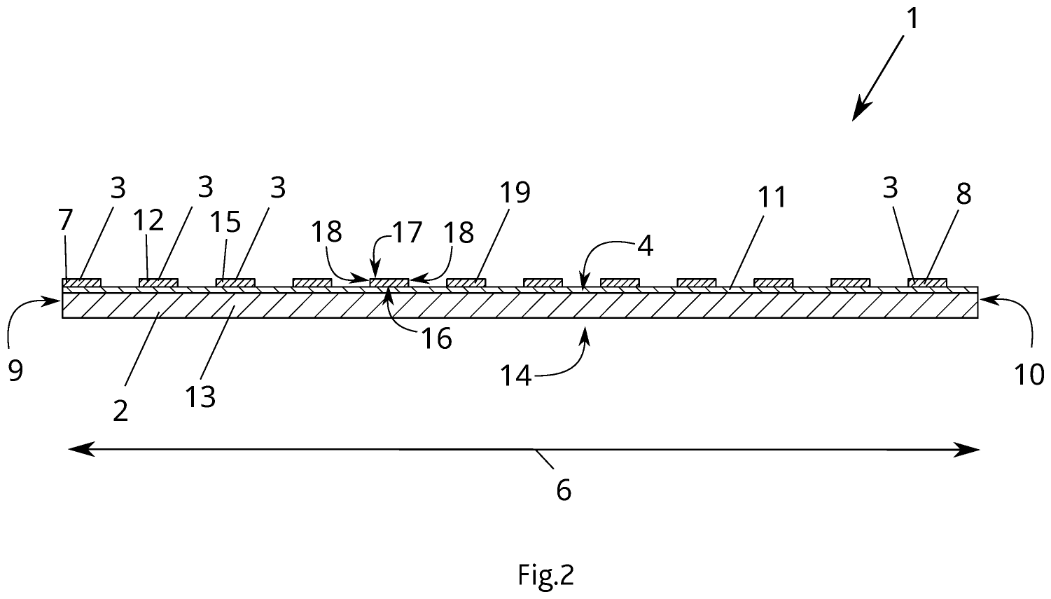

FIG. 2 shows a side view of the wall element of FIG. 1 from below (in the position shown in FIG. 1).

FIG. 1 shows a wall element 1 for thermal insulation of an interior wall surface (not shown) with an elastic insulating panel 2 (see FIG. 2) with twelve slat-shaped lamellas 3. The slat-shaped lamellas 3 are spaced apart from one another and arranged parallel to one another on a front side 4 (see FIG. 2) of the elastic insulating panel 2, so that the elastic insulating panel 2 is mechanically stabilised by the slat-shaped lamellas 3. The arrangement of the slat-shaped lamellas 3 is equidistant. The normal distance between each two adjacent lamellas 3 is therefore the same in each case. The lamellas 3 are of identical design in this exemplary embodiment.

Alternatively, the lamellas 3 may differ from one another. The insulating panel 2 extends laterally on the one hand in a longitudinal direction 5 and on the other hand in a transverse direction 6. The transverse direction 6 is normal to the longitudinal direction 5. Both the longitudinal direction 5 and the transverse direction 6 are parallel to the main plane of extension of the wall element 1 in the illustrated state, i.e. without bending. The insulating panel 2 extends further in the longitudinal direction 5 than in the transverse direction 6. The slat-shaped lamellas 3 are aligned parallel to the longitudinal direction 5. Therefore, the insulating panel 2 is stabilised in particular in the longitudinal direction 5, while remaining flexible in the transverse direction 6 in order to be easily attached to curved interior wall surfaces. In this exemplary embodiment, the slat-shaped lamellas 3 extend less far in the longitudinal direction 5 than the insulating panel 2. The extent of the insulating panel 2 is 2.5 m in the longitudinal direction 5 and 0.6 m in the transverse direction 6. The thickness of the insulating panel is 1.3 cm. The extent of the lamellas 3 is 247.5 cm in the longitudinal direction 5 and 2.5 cm in the transverse direction 6.

The wall element 1 has a first outer lamella 7 and a second outer lamella 8. The first outer lamella 7 is that of the slat-shaped lamellas 3 that has the smallest normal distance from a first end face 9. The second outer lamella 8 is the one having the smallest normal distance from a second end face 10. The first end face 9 and the second end face 10 are parallel to the longitudinal direction 5 and are transverse, in this case normal, to the front side 4. If two wall elements 1 are attached next to one another, the first end face 9 of a wall element 1 lies against the second end face 10 of a further already fastened wall element (not shown). Consequently, the first outer lamella 7 of the wall element 1 is adjacent to the second outer lamella 8 of the further already fastened wall element. In order to determine the normal distance corresponding to the normal distance between two adjacent lamellas 3 on the same wall element 1, the sum of the normal distance between the first outer lamella 7 and the first end face 9 and the normal distance between the second outer lamella 8 and the second end face 10 of the (same) wall element 1 may correspond to the normal distance between two adjacent lamella 3 of a wall element 1. In this case, the first outer lamella 7 ends with the first end face 9. In the exemplary embodiment illustrated, the normal distance between the second outer lamella 8 and the second end face 10 corresponds to the normal distance between two adjacent lamellas 3. If a further identical wall element 1 is placed with the first end face 9 against the second end face 10 of the wall element, a total of twenty-four slat-shaped lamellas 3 is visible, each of which being arranged equidistantly.

Alternatively, a first longitudinal section (not shown) of a first outer slat-shaped lamella 7 may extend across the front side 4 of the elastic insulating panel 2, and a second longitudinal section (not shown) of the first outer slat-shaped lamella 7 may not extend across the front side 4 of the elastic insulating panel 2. In this case, too, it can be ensured that the first outer lamella 7 of a wall element 1 has a normal distance from the second outer lamella 8 of a further already fastened wall element, which corresponds to the normal distance between two adjacent lamellas 3 on a wall element 1. For this purpose, a projection of the first outer lamella 7 can also be considered. The lamellas 3 each have two longitudinal side faces 18 (see FIG. 2 for details). When the second longitudinal section is not extended over the front side 4 of the elastic insulating panel 2, the second longitudinal section has a longitudinal side face 18, which is also not extended over the front side 4 of the insulating panel 2. The projection is the normal distance of the longitudinal side face 18, which does not extend over the front side 4 of the insulating panel 2, from the first end face 9. In order to determine the normal distance between the first outer lamella 7 and the second outer lamella 8 of a further already fastened wall element, which corresponds to the normal distance between two adjacent lamellas 3 on the same wall element 1, the normal distance between the second outer lamella 8 and the second end face 10 may correspond to the sum of the normal distance between two lamellas 3 and the projection. If a further identical wall element 1 is placed with the first end face 9 against the second end face 10 of the wall element, a total of twenty-four slat-shaped lamellas 3 would also be visible in this case, each of which being arranged equidistantly. A joint between two adjacent wall elements 1 would be covered by the first outer lamella 7 by extending the first outer lamella 7 over the joint.

A sound absorber 11, in this case a felt layer, is arranged between the insulating panel 2 and the lamellas 3 (see FIG. 2 for details).

FIG. 2 shows a side view of the wall element 1 of FIG. 1. The sound absorber 11 is arranged between the insulating panel 2 and the lamellas 3. The sound absorber 11 is attached to the front side 4 of the insulating panel 2. The lamellas 3 are adhered to the sound absorber 11.

The slat-shaped lamellas 3 comprise a wood-based material 12, in this case solid wood. The elastic insulating panel 2 comprises a rubber elastomer 13 and is water vapour diffusion-inhibiting with an Sa-value of approximately 500 m. The elastic insulating panel 2 has such an elasticity that unevennesses on an interior wall surface of up to 2 mm can be compensated and that a continuous water vapour diffusion-tight insulating layer (not shown) can be formed on the interior wall surface by means of the elastic insulating panel 2 and a further elastic insulating panel (not shown) of an adjacent wall element (not shown). The average thermal conductivity of the elastic insulation board 2 is below 0.04 watts per metre per kelvin (W/m K), in this case about 0.03 watts per metre per kelvin (W/m K).

An adhesive surface (not shown), in this case formed by double-sided adhesive tape, is provided on a back side 14 of the insulating panel 2. The back side 14 is a side of the insulating panel 2 facing away from the front side 4. To protect the adhesive surface from contamination such as dust, the adhesive surface is covered with a protective film (not shown). The adhesive surface is suitable for permanently fixing the wall element to an interior wall surface. When the wall element 1 is used as intended, the back side 14 of the insulating panel 2 is adhered to an interior wall surface by means of the adhesive surface and thus attached to the interior wall surface.

The slat-shaped lamellas 3 have a cross-sectional area 19 of more than 36 mm², in this case approximately 165 mm², the cross-sectional area 19 being normal to a main axis of the lamella 3. The width of the lamellas 3 in the transverse direction 6 is 2.5 cm and the height, i.e. the thickness, of the lamellas 3 is 0.66 cm.

The lamellas 3 have a body 15 made of a wood-based material, in this case solid wood. The body 15 has a back side 16, wherein the back side 16 of the lamella 3 is adhered to the sound absorber 11. The body 15 of the lamella 3 also has a front side 17 opposite the back side 16, as well as two longitudinal side faces 18. As an alternative to the illustrated embodiment, a decorative layer can be arranged on the body 15, wherein the decorative layer can extend at least over the front side 17 of the lamella. Furthermore, the decorative layer may extend over at least one longitudinal side face 18 of the body 15 of the lamella 3. For example, the decorative layer may have a real wood veneer.

For thermal insulation of an interior wall surface with the wall element 1 from FIGS. 1 and 2, the following steps are carried out at least once and optionally repeated until the interior wall surface is completely covered with wall elements 1.
providing a wall element 1;
peeling off the protective film from the adhesive surface;
attaching the wall element 1 to the interior wall surface by adhering by means of the adhesive surface, wherein the first end face 9 of the elastic insulating panel 2 flushes with the second end face 10 of a further elastic insulating panel of an already fastened wall element, wherein the first end face 9 and the second end face 10 are normal to the front side 4 of the elastic insulating panel 2. When attaching the wall element 1, a normal force from the first end face 9 of the elastic insulating panel 2 acts laterally on the second end face 10 of the further elastic insulating panel of the already fastened wall element, so that the elastic insulating panel 1 forms a continuous insulating layer on the interior wall surface with the further elastic insulating panel of the already fastened adjacent wall element.

Depending on their total surface area, an interior wall surface can be provided with wall elements 1 within a few hours. The use of the wall element 1 eliminates the need for time-consuming and complicated work steps such as glue application, joint filling, adhering, plastering and/or painting. The thermal insulation achieved by means of the wall elements 1 can lead to energy savings of approximately 20% up to 50%.

1. A wall element (1) for thermal insulation of an interior wall surface, comprising an elastic insulating panel (2),
further comprising
at least two slat-shaped lamellas (3), the at least two slat-shaped lamellas (3) being spaced apart from one another and arranged parallel to one another on a front side (4) of the elastic insulating panel (2), so that the elastic insulating panel (2) is mechanically stabilised by the slat-shaped lamellas (3), the slat-shaped lamellas (3) comprising engineered wood (12).

2. The wall element (1) according to claim 1, wherein the insulating panel (2) extends laterally in a longitudinal direction and laterally in a transverse direction, wherein the insulating panel (2) extends further in the longitudinal direction (5) than in the transverse direction (6), wherein the slat-shaped lamellas (3) are aligned parallel to the longitudinal direction (5).

3. The wall element (1) according to claim 1, wherein the elastic insulating panel (2) is water vapour diffusion-inhibiting.

4. The wall element (1) according to claim 3, wherein the elastic insulating panel (2) has such an elasticity that unevennesses on an interior wall surface of up to 7 mm can be compensated for, and that a continuous water vapour diffusion-inhibiting insulating layer (2) can be formed on the interior wall surface by means of the elastic insulating panel and a further elastic insulating panel of an adjacent wall element.

5. The wall element (1) according to claim 1, wherein said elastic insulating panel (2) has an average thermal conductivity of at most 0.04 watts per metre per kelvin (W/m K).

6. The wall element (1) according to claim 1, wherein the elastic insulating panel (2) comprises rubber.

7. The wall element (1) according to claim 1, wherein the wood-based material (12) is solid wood or engineered wood comprising a medium-density wood fibre material, high-density wood fibre material (“HDF”), a wood chip material or plywood.

8. The wall element (1) according to claim 1, wherein at least three slat-shaped lamellas (3) are provided, wherein the slat-shaped lamellas (3) are arranged equidistantly on the front side of the elastic insulating panel.

9. The wall element (1) according to claim 1, wherein a first longitudinal section of an outer slat-shaped lamella extends across the front side (4) of the elastic insulating panel (2), and a second longitudinal section of the outer slat-shaped lamella does not extend across the front side of the elastic insulating panel (2).

10. The wall element (1) according to claim 1, wherein the slat-shaped lamellas (3) have a cross-sectional area (19) of at least 36 mm², wherein the cross-sectional area (19) is normal to a main axis of the lamella.

11. The wall element (1) according to claim 1, wherein an adhesive surface, formed by double-sided adhesive tape, is provided on a back side (14) of the insulating panel (2), wherein the adhesive surface is covered with a protective film, wherein the back side (14) is a side of the insulating panel (2) facing away from the front side (4), wherein the adhesive surface is suitable for permanently fixing the wall element (1) to an interior wall surface.

12. The wall element (1) according to claim 1, characterised in that a sound absorber (11), is attached to the front side (4) of the elastic insulating panel (2), wherein the sound absorber (11) is arranged between the elastic insulating panel (2) and the slat-shaped lamellas (3).

13. A method for the thermal insulation of an interior wall surface, wherein the method comprises at least one repetition of the following steps:
providing a wall element (1) with an elastic insulating panel;
attaching the wall element (1) to an interior wall surface, wherein a first end face (9) of the elastic insulating panel (2) flushes with a second end face (10) of a further elastic insulating panel of an already fastened wall element;
wherein
the wall element (1) has at least two slat-shaped lamellas (3), wherein the at least two slat-shaped lamellas (3) are spaced apart from one another and are arranged parallel to one another on a front side (4) of the elastic insulating panel (2) in order to mechanically stabilise the elastic insulating panel (2) during the attachment.

14. The method according to claim 13, wherein when attaching the wall element 1, a normal force from the first end face (9) of the elastic insulating panel (2) acts laterally on the second end face (10) of the further elastic insulating panel of the already fastened wall element, so that the elastic insulating panel (2) forms a continuous insulating layer on the interior wall surface with the further elastic insulating panel of the already fastened adjacent wall element (1).

15. The method according to claim 13, wherein an adhesive surface is provided on a back side (14) of the elastic insulating panel (2), wherein the back side (14) is a side of the elastic insulating panel (2) facing away from the front side (4), wherein the adhesive surface is covered with a protective film, wherein attaching the wall element (1) comprises adhering the wall element (1) by means of the adhesive surface, wherein the method further has the following step before attaching the wall element (1):
peeling off the protective film from the adhesive surface.
